(19) United States
(12) Patent Application Publication
(10) Pub. No.: US 2025/0136368 A1
(43) Pub. Date: May 1, 2025

(54) REFUSE DETECTION AND SORTING SYSTEM FOR A REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Oshkosh, WI (US); Johnny Bui, Oshkosh, WI (US); Nagabhushana Sharma Gurumurthy, Oshkosh, WI (US); Monika Nagalla, Oshkosh, WI (US); John Zucca, Oshkosh, WI (US)

(73) Assignee: Oshkosh Corporation, Oshkosh, WI (US)

(21) Appl. No.: 18/919,065

(22) Filed: Oct. 17, 2024

Related U.S. Application Data
(60) Provisional application No. 63/545,992, filed on Oct. 27, 2023.

(51) Int. Cl. B65F 3/02

(52) U.S. Cl. CPC B65F 3/02; B65F 2210/128; B65F 2210/138; B65F 2210/168

(57) ABSTRACT

A includes a camera and processing circuitry. The camera can be oriented outwards from the refuse vehicle and is configured to obtain image data of a refuse container. The processing circuitry can be configured to obtain the image data. The processing circuitry can also configured to predict, based on the image data, a type of refuse in the refuse container. The processing circuitry can also be configured to, responsive to determining that the refuse vehicle is configured to collect the type of refuse in the refuse container, operate a lift apparatus of the refuse vehicle to empty the refuse in the refuse container into a hopper of the refuse vehicle.

### CROSS-REFERENCE TO RELATED PATENT APPLICATIONS

This application claims the benefit of or priority to U.S. Provisional Application No. 63/545,992, filed Oct. 27, 2023, the entire disclosure of which is incorporated by reference herein.

### BACKGROUND

The present disclosure generally relates to the field of refuse vehicles. More specifically, the present disclosure relates to control systems for refuse vehicles.

### SUMMARY

One embodiment of the present disclosure is a system for a refuse vehicle. The system includes a camera and processing circuitry. The camera can be oriented outwards from the refuse vehicle and is configured to obtain image data of a refuse container. The processing circuitry can be configured to obtain the image data. The processing circuitry can also configured to predict, based on the image data, a type of refuse in the refuse container. The processing circuitry can also be configured to, responsive to determining that the refuse vehicle is configured to collect the type of refuse in the refuse container, operate a lift apparatus of the refuse vehicle to empty the refuse in the refuse container into a hopper of the refuse vehicle.

The processing circuitry may be configured to use an image analysis technique using the image data to identify a feature of the refuse container and infer the type of refuse based on the identified feature of the refuse container. The feature may include at least one of a color of at least a portion of the refuse container, a size of the refuse container, a shape of the refuse container, a quick response code, a barcode, or a detected text on the refuse container.

The system may also include a radio frequency identification (RFID) configured to wirelessly emit energy to an RFID tag of the refuse container. The processing circuitry may be configured to predict the type of refuse in the refuse container based on a received response from the RFID tag of the refuse container.

The processing circuitry can also be configured to, responsive to determining that the refuse vehicle is configured to collect the type of refuse in the refuse container, operate an actuator of a hopper partition such that the refuse is directed to a corresponding one of multiple refuse compartments of the refuse vehicle as the lift apparatus empties the refuse into the hopper. The processing circuitry can also be configured to, in response to determining that the refuse vehicle is not configured to collect the type of refuse in the refuse container, transmit a notification to a route planning system comprising a location of the refuse container. The route planning system can be configured to use the notification to dispatch a different refuse vehicle that is configured to collect the type of refuse in the refuse container to the location of the refuse container.

Another embodiment of the present disclosure is a refuse vehicle. The refuse vehicle includes a lift apparatus and a system. The system includes a camera and processing circuitry. The camera is oriented outwards from the refuse vehicle. The camera is configured to obtain image data of a refuse container. The processing circuitry is configured to obtain the image data. The processing circuitry is also configured to predict, based on the image data, a type of refuse in the refuse container. The processing circuitry is also configured to, responsive to determining that the refuse vehicle is configured to collect the type of refuse in the refuse container, operate the lift apparatus of the refuse vehicle to empty the refuse in the refuse container into a hopper of the refuse vehicle.

Another embodiment of the present disclosure is a method of operating a refuse vehicle. The method includes obtaining image data of a refuse container from a camera of the refuse vehicle. The method also includes predicting a type of refuse within the refuse container based on the image data of the refuse container. The method also includes, in response to determining that the refuse vehicle is equipped to collect the type of refuse in the refuse container, operating a lift apparatus of the refuse vehicle to empty the refuse into a hopper of the refuse vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a diagram illustrating a refuse vehicle equipped with a refuse detection and sorting system, according to an exemplary embodiment;

FIG. 7 is a diagram illustrating different features of a refuse container that are usable by the refuse detection and sorting system of FIG. 6 to infer a type of refuse in the refuse container, according to an exemplary embodiment;

FIG. 8 is a block diagram of the refuse detection and sorting system of FIG. 6, according to an exemplary embodiment;

FIG. 9 is a diagram illustrating a hopper of the refuse vehicle of FIG. 6 including a movable partition to direct refuse into different refuse compartments, according to an exemplary embodiment;

FIG. 10 is a flow diagram of a process for detecting and sorting refuse, according to an exemplary embodiment; and

FIG. 11 is a diagram of another hopper of a refuse vehicle including movable partitions, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle can include a detection and sorting system. The detection and sorting system includes a variety of sensors position on the refuse vehicle such as cameras, radio frequency identification transponders, QR code scanners, barcode scanners, etc. The detection and sorting system also includes a controller configured to obtain the sensor feedback and infer, based on the sensor data of a nearby refuse container, a type of refuse within the refuse container or a type of refuse container. For example, the controller may identify using an image recognition technique if the refuse container is a recycling bin or a garbage can. The controller may operate a lift apparatus of the refuse vehicle and an adjustable hopper partition in order to sort the refuse of the detected type into a corresponding compartment of the refuse vehicle. If the refuse vehicle is not a multi-compartment vehicle, and is not equipped to collect the type of refuse that is predicted to be in the refuse container, the controller may provide a notification to a route planning system to schedule pickup of the refuse in the refuse container or to add the location of the refuse container to a different refuse vehicle's route.

### Refuse Vehicle

### Front-Loading Configuration

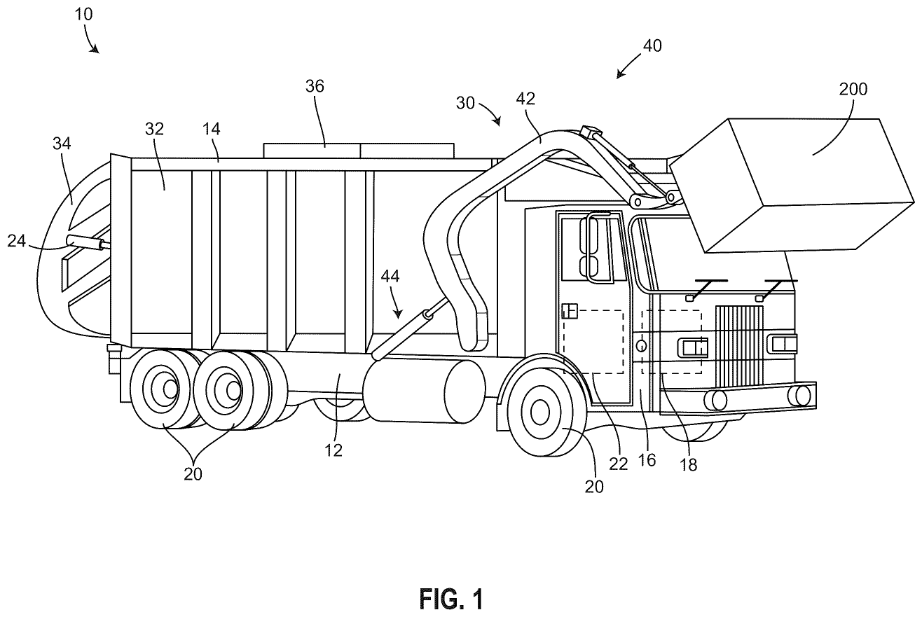

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558, 183, filed Dec. 12, 2021, the entire disclosure of which is incorporated by reference herein.

### Rear-Loading Configuration

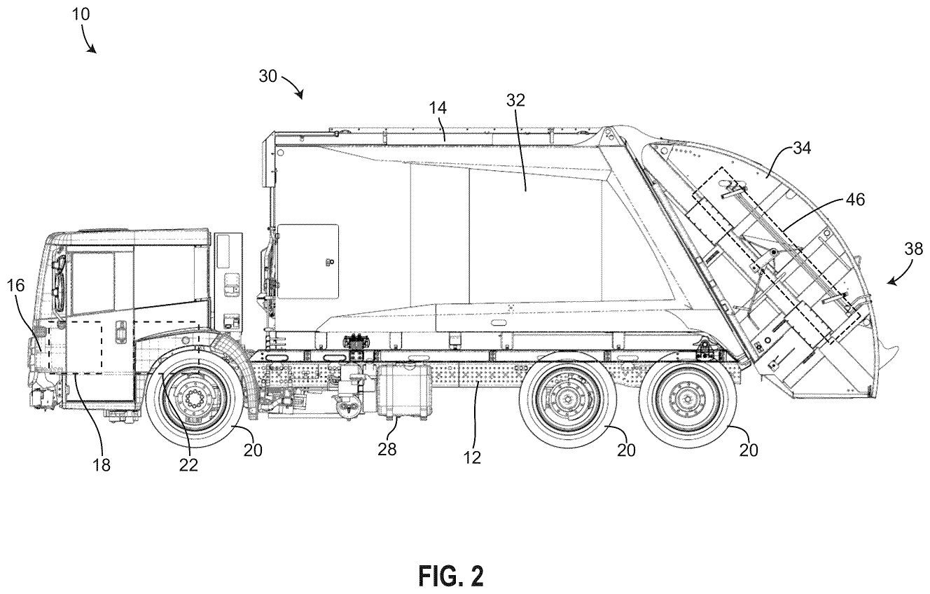

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

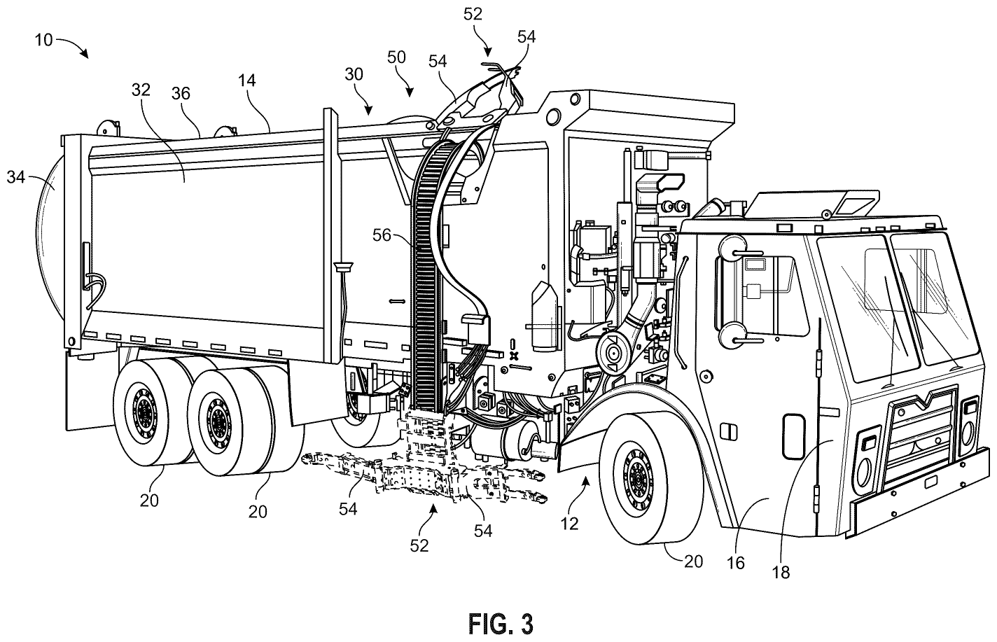

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

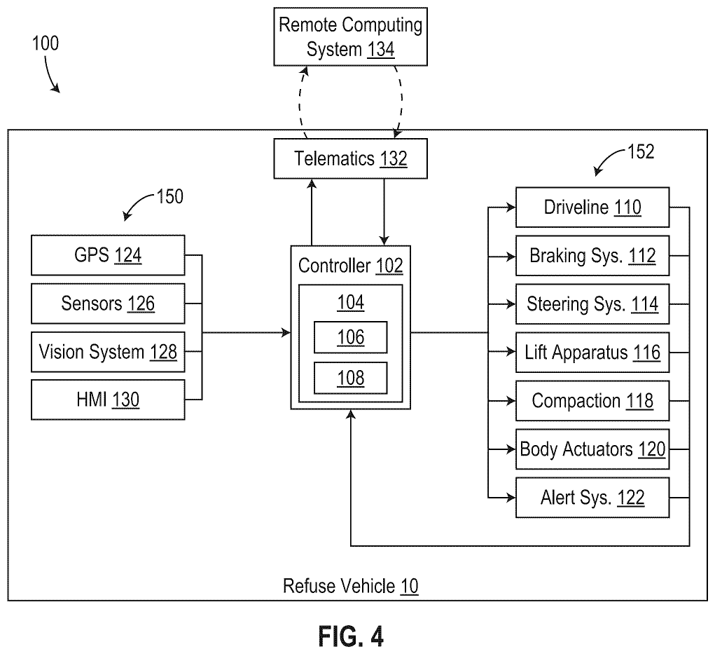

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126, a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes processing circuitry 104 including a processor 106 and memory 108. Processing circuitry 104 can be communicably connected with a communications interface of controller 102 such that processing circuitry 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via processing circuitry 104 and includes computer code for executing (e.g., by at least one of processing circuitry 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

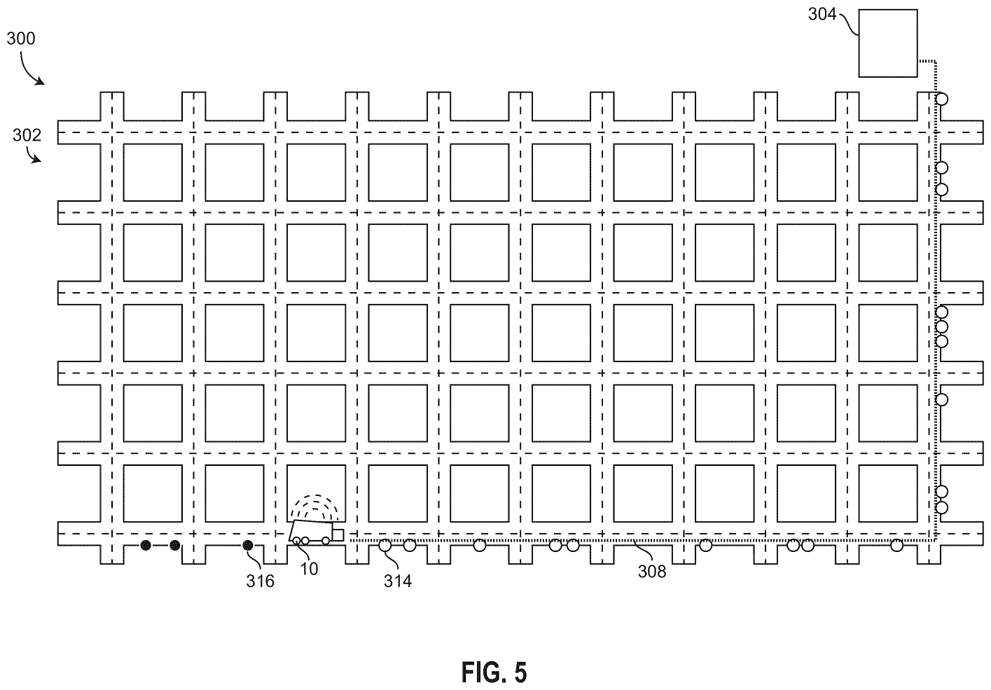

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Refuse Stream Sorting System

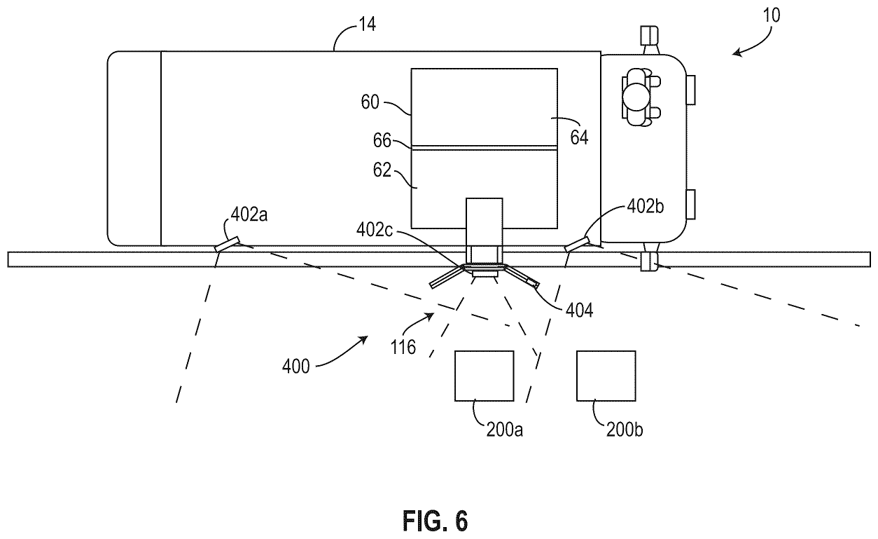

Referring to FIGS. 6-10, the refuse vehicle 10 may be equipped with a stream sorting system 400 that is configured to identify a type of refuse within a waste receptacle (e.g., the refuse container 200) and ensure that the refuse is emptied into an appropriate chamber or collected by a refuse vehicle that is configured to collect that type of refuse. The stream sorting system 400 facilitates sorting garbage from recycling or maintaining segregation of different types of refuse.

Referring particularly to FIG. 6, the stream sorting system 400 may be provided on a side-loading refuse vehicle 10. The refuse vehicle 10 includes the lift apparatus 116 on a curbside of the refuse vehicle 10. The lift apparatus 116 may have the form of a robotic arm having multiple articulable joints and a claw or grabber, a tracked lift apparatus including a grabber, or any combination thereof. The stream sorting system 400 can include multiple cameras, shown as first camera 402a, second camera 402b, and third camera 402c. While the cameras 402 are shown disposed on a curb-side of the refuse vehicle 10, the cameras 402 may be positioned on a front of the refuse vehicle 10, a rear, on different corners, at different heights, at different orientations, on a street-side of the refuse vehicle 10, etc. More generally, the cameras 402 are directed outwards such that refuse containers 200 (e.g., first refuse container 200a and second refuse container 200b) are within a field of view of the cameras 402. The cameras 402 may obtain image data of the refuse containers 200 as the refuse vehicle 10 arrives at the refuse containers 200. As shown in FIG. 6, the third camera 402c may be disposed on a claw or portion of the lift apparatus 116.

The refuse vehicle 10 may be a multi-chambered vehicle including at least two refuse compartments, each for a different type of refuse, or may be a single-chambered vehicle including a single refuse compartment for one type of refuse. For example, the refuse vehicle 10 may be a garbage truck or a recycling truck with a single corresponding refuse compartment for garbage or recycling. The refuse vehicle 10 can also be a combination of a garbage truck and a recycling truck so that the refuse vehicle 10 can collect both garbage and recycling. If the refuse vehicle 10 is configured to collect both garbage and recycling (e.g., different types of refuse), the refuse vehicle 10 may include a hopper 60 having two hopper openings for the different types of refuse, shown in FIG. 6 as first hopper opening 62 and second hopper opening 64. Refuse of a first type (e.g., garbage) may be emptied into the first hopper opening 62 and refuse of a second type (e.g., recycling) may be emptied into the second hopper opening 64. The lift apparatus 116 may be configured to selectively transport and empty the refuse containers 200 into one of the first hopper opening 62 or the second hopper opening 64. In some embodiments, the hopper 60 has a partition 66 that is transitionable between different positions or states in order to allow access to one of the first hopper opening 62 or the second hopper opening 64, and to limit access to another of the first hopper opening 62 or the second hopper opening 64. In this way, the lift apparatus 116 and the hopper 60 may be operated to empty refuse into one of a first refuse compartment or a second refuse compartment.

The stream sorting system 400 can also include a radio frequency identification (RFID) detector 404 (e.g., an RFID reader, an RFID transponder, etc.) that is configured to wirelessly transmit energy to proximate RFID tags. The RFID detector 404 may monitor responses that are received from nearby RFID tags. In particular, the refuse containers 200 may include RFID tags that are configured to provide a response signal to the RFID detector 404. The RFID detector 404 may be positioned on the lift apparatus 116 or on an exterior surface of the refuse vehicle 10 such that the RFID detector 404 is sufficiently close to the refuse containers 200 to communicate with RFID tags. The stream sorting system 400 may also include separate QR code scanners or barcode scanners positioned on the lift apparatus 116 (e.g., on the grabber assembly 52) or on a side of the refuse vehicle 10.

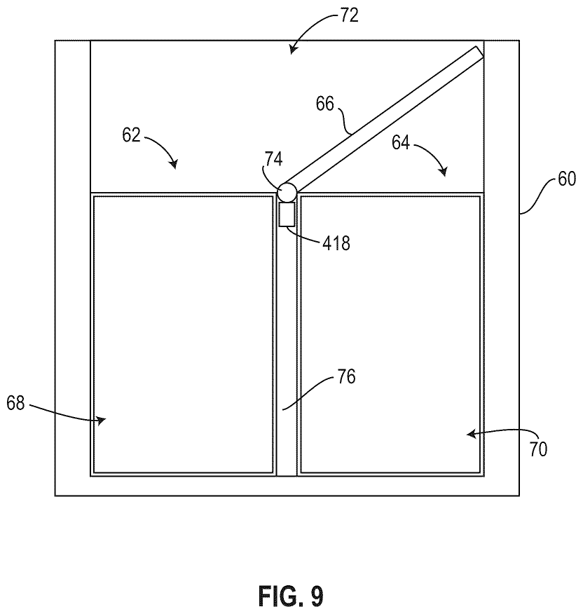

Referring particularly to FIG. 9, the hopper 60 is shown to include the first hopper opening 62 and the second hopper opening 64. The hopper 60 includes an overall hopper opening 72 through which refuse may be emptied into the first hopper opening 62 or the second hopper opening 64. The hopper 60 also includes a wall 76 that defines a boundary between the first hopper opening 62 and the second hopper opening 64. The first hopper opening 62 provides access to a first compartment 68 within the body 14 of the refuse vehicle 10, while the second hopper opening 64 provides access to a second compartment 70 within the body 14 of the refuse vehicle 10. The first compartment 68 may be a garbage compartment for the collection and transportation of garbage while the second compartment 70 may be a recycling compartment for the collection and transportation of recyclable materials. The hopper 60 also includes the partition 66 (e.g., a divider, a panel, a movable member, etc.) that is repositionable between a first position as shown and a second position. When the partition 66 is in the first position as shown, the second hopper opening 64 is limited from access while the first hopper opening 62 is accessible from the overall hopper opening 72. Similarly, when the partition 66 is in the second position, the first hopper opening 62 is limited from access while the second hopper opening 64 is accessible from the overall hopper opening 72. The partition 66 is shown pivotally coupled with a pivot point 74 at a top of the wall 76 and operably coupled with an actuator 418 (e.g., a partition actuator) such as an electric motor, a hydraulic cylinder, etc. The pivotal coupling and rotation of the partition 66 as shown and described herein with reference to FIG. 9 is illustrative only and should not be understood as limiting. For example, the partition 66 may be formed by a pair of trap doors that each limit or allow access to a corresponding one of the first hopper opening 62 or the second hopper opening 64 and are independently operable to transition between an open state or a closed state. In some embodiments, the operability of the partition 66 between a first position and a second position or a first orientation and a second orientation is optional if the lift apparatus 116 is capable of operating to empty contents of the refuse containers 200 into the first hopper opening 62 or the second hopper opening 64.

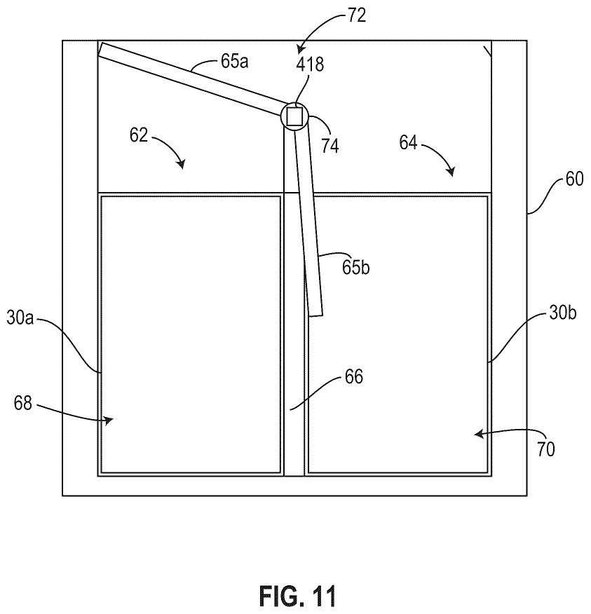

Referring to FIG. 11, the hopper may include a first arm 65a and a second arm 65b that are pivotally coupled at a single end with pivot point 74 at the top of partition 66. In some embodiments, the hopper 60 includes a pair of hopper actuators 418 that are each operably coupled with a corresponding one of the arms 65. Each of the arms 65 may be transitionable, by operation of the hopper actuators 418, into an open position and a closed position. As shown in FIG. 11, the first arm 65a is in the closed position such that refuse emptied into the hopper 60 through the overall hopper opening 72 is limited from being directed into the first hopper opening 62. On the other hand, the second arm 65b is shown in the open position such that refuse emptied into the overall hopper opening 72 is allowed to fall into the second hopper opening 64 such that the refuse can be directed into the second refuse compartment 30b through the second compartment opening 70. Each of the arms 65 may be transitionable between the open position and the closed position independently to direct refuse into either the first refuse compartment 30a or the second refuse compartment 30b.

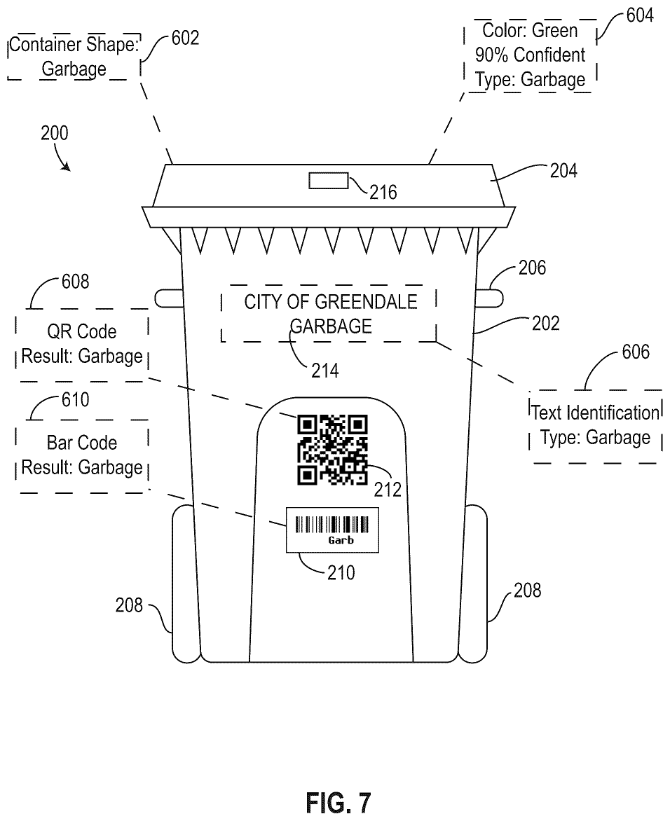

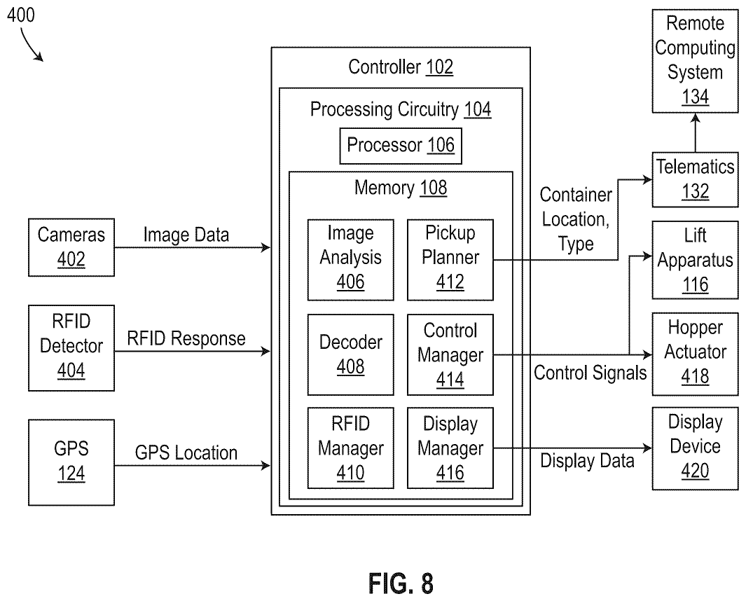

Referring to FIGS. 7 and 8, the controller 102 may be configured to implement various control and display functionality of the stream sorting system 400. The stream sorting system 400 includes the cameras 402, the RFID detector 404, the GPS system 124, the controller 102, the telematics 132, the lift apparatus 116, the hopper actuator 418, and a display device 420, according to some embodiments. As shown in FIG. 7, a given refuse container 200 can include a body 202 that defines a compartment or inner volume for refuse, a pair of wheels 208, handles 206, a lid 204, and printed text 214 or decals. The refuse container 200 may also include an RFID tag 216. The refuse container 200 may also include a quick response (QR) code 212. The refuse container 200 may also include a barcode 210. In some embodiments, one or more portions of the refuse container 200 have different colors to indicate whether the refuse container 200 contains garbage or recyclable materials.

As shown in FIG. 8, the memory 108 of the controller 102 includes image analysis 406, a decoder 408, an RFID manager 410, a pickup planner 412, a control manager 414, and a display manager 416. The image analysis 406 may obtain the image data from the cameras 402 of the refuse containers 200 that are within the field of view of the cameras 402. The image analysis 406 implemented by the processing circuitry 104 of the controller 102 is performed in order to identify a feature of the refuse container 200 in order to predict or identify a type of refuse that is within the refuse container 200 (e.g., whether the refuse container 200 is a recycling container or a garbage can). The image analysis 406 may include identifying a color of the refuse container 200 or one or more portions of the container 200 (e.g., a color of the lid 204, a color of the body 202, etc.), and identifying, based on the detected color of the refuse container 200, the type of refuse that is within the refuse container 200. The image analysis 406 may also be configured to predict the type of refuse within the refuse container 200 based on a shape or size of the refuse container 200. For example, if standard refuse containers are used with different sizes and shapes for recycling as opposed to garbage, the image analysis 406 can be implemented in order to identify, based on the size and shape, whether the refuse container 200 is a recycling container or a garbage can. The image analysis 406 may use the size, shape, and position of features such as the body 202, the handles 206, the lid 204, the wheels 208, etc., alone or in combination with each other.

The image analysis 406 may also identify the text 214 on the refuse container 200. For example, the text 214 on the refuse container may indicate whether the refuse container 200 is a garbage can or a recycling can. The image analysis 406 may perform an optical character recognition (OCR) technique and use a database of terms to identify, based on the text 214, whether the refuse container 200 is a recycling container or a garbage can (e.g., to predict the type of refuse that is within the refuse container 200).

The image analysis 406 may be configured to implement any machine learning, neural network, or artificial intelligence in order to identify whether the refuse container 200 is a garbage can or a recycling container (e.g., to predict a type of refuse within the refuse container 200). For example, the controller 102 may implement the image analysis 406 by performing any of the functionality as described in greater detail in U.S. application Ser. No. 16/758,834, filed Apr. 23, 2020, the entire disclosure of which is incorporated by reference herein. The image analysis 406 may be implemented locally on the controller 102 or remotely by the remote computing system 134. The controller 102, or more generally, the stream sorting system 400, may also be configured to perform any of the functions or techniques to identify the type of refuse in the refuse container 200 or identify the type of refuse container 200 as described in greater detail in U.S. application Ser. No. 17/189,740, filed Mar. 2, 2021, the entire disclosure of which is incorporated by reference herein.

The decoder 408 can also be configured to obtain the image data from the cameras 402 and identify QR codes or bar codes in the image data of the refuse container 200. The decoder 408 may implement a QR code or barcode decoding technique based on the image data of the QR code 212 or the barcode 210 to determine results. The results may indicate a type of refuse container 200 that is present in the image data (e.g., a garbage can or a recycling bin).

The RFID manager 410 is configured to receive the RFID response from the RFID scanner 404 obtained from the RFID tag 216 of the refuse container 200. The RFID manager 410 may analyze the RFID response to determine, based on the RFID response, the type of refuse that should be present in the refuse container 200.

The image analysis 406, the decoder 408, and the RFID manager 410 may be configured to determine, using the above described functionality, a predicted type of refuse that is present in the refuse container 200 and provide their results to the pickup planner 412, the control manager 414, and the display manager 416. The pickup planner 412 may determine, based on the type of refuse in the refuse container 200 and abilities of the refuse vehicle 10 (e.g., the type of refuse that the refuse vehicle 10 is capable of collecting, whether the refuse vehicle 10 has multiple refuse compartments, a fill level of refuse in the refuse compartments, etc.), if the refuse vehicle 10 is capable of emptying the refuse of the refuse container 200 into the hopper 60. If the refuse vehicle 10 is not capable of emptying the refuse of the refuse container 200, the pickup planner 412 may use the GPS location as the container location, and the type of refuse in the refuse container to schedule a pickup by a subsequent refuse vehicle. The pickup planner 412 can provide the container location and the type of refuse in the refuse container 200 to the remote computing system 134 for scheduled pickup at a later time via the telematics 132.

The control manager 414 is configured to use the results of any of the image analysis 406, the decoder 408, or the RFID manager 410 to operate at least one of the lift apparatus 116 or the hopper actuator 418 to empty the contents of the refuse container 200 into the hopper 60 of the refuse vehicle 10. For example, if the refuse vehicle 10 is a single compartment refuse vehicle that is configured to collect the type of refuse that is within the refuse container 200, the control manager 414 may provide control signals to the lift apparatus 116 to grasp, lift, and empty the refuse of the refuse container 200 into the hopper 60. Similarly, if the refuse vehicle 10 is a multi-compartment refuse vehicle, that control manager 414 may operate the hopper actuator 418 to transition the partition 66 into a desired state and operate the lift apparatus 116 to empty contents of the refuse container 200 into the corresponding type of refuse compartment of the refuse vehicle 10 (e.g., the garbage compartment if the type of refuse in the refuse container 200 is garbage or the recycling compartment if the type of refuse in the refuse container 200 is recycling). In some embodiments, the control manager 414 is configured to operate the lift apparatus 116 without operating the hopper actuator 418 to empty the contents of the refuse container 200 into the appropriate hopper opening of the hopper 60 based on the type of refuse in the refuse container 200.

Referring to FIGS. 7 and 8, the display manager 416 may be configured to generate display data and operate the display device 420 to provide the display data to an operator of the refuse vehicle 10 or a user that remotely controls or monitors the refuse vehicle 10. The display data may include various callouts overlaid or superimposed onto a real-world or digital image of the refuse container 200. The callouts may indicate the results of the image analysis 406 and can include lines indicating the corresponding features. For example, as shown in FIG. 7, the display data may include a first callout 602 or visual indication that indicates the results of a container shape (e.g., container shape: garbage). The display data may also include a second callout 604 or visual indication that indicates the results of image analysis of particular features (e.g., color of a particular feature or component such as the lid 204, confidence of results, corresponding type). The display data may also include a third callout 606 that indicates the results of text identification (e.g., OCR of the detected text 214 of the refuse container 200). The display data may also include a fourth callout 608 that indicates the results of QR decoding (e.g., QR code result: garbage). The display data may also include a fifth callout 610 that indicates the results of barcode decoding (e.g., bar code result: garbage).

It should be understood that while FIGS. 6-10 as described herein refer to only two types of refuse (i.e., garbage and recycling), the stream sorting system 400 may be configured to identify any number of types of refuse or refuse containers using the techniques described herein. For example, if different municipalities have separate containers for cardboard recycling as opposed to glass recycling, in addition to having garbage cans, the stream sorting system 400 may be configured to determine which of the three different types of refuse are likely present in the refuse containers 200.

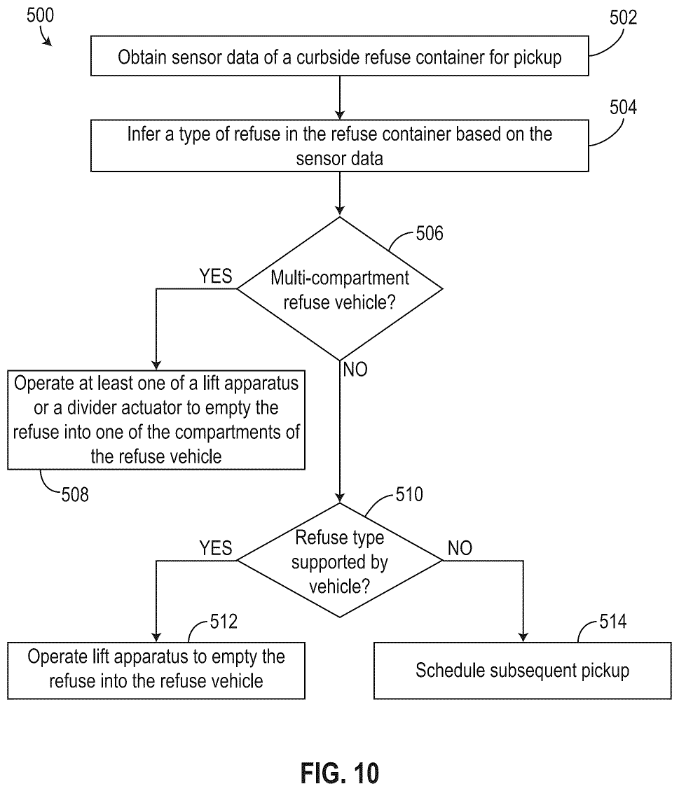

Referring to FIG. 10, a flow diagram of a process 500 for sorting refuse from different refuse containers includes steps 502-514, according to some embodiments. The process 500 may be performed by the stream sorting system 400 of the refuse vehicle 10. The process 500 advantageously facilitates keeping different types of refuse separate as desired. For example, refuse vehicles may autonomously transport along routes and collect garbage and recycling. The refuse vehicles may be equipped with detection sensors in order to infer, based on the feedback from the detection sensors, which of multiple types of refuse are present in the refuse containers. Advantageously, the process 500 facilitates fully autonomous or semi-autonomous waste collection without requiring an operator of the vehicle to manually exit the vehicle and check or move refuse containers.

The process 500 includes obtaining sensor data of a curbside refuse container for pickup (step 502), according to some embodiments. The refuse container may be position on a curb, in front of a refuse vehicle, behind a refuse vehicle, etc. The sensor data may include image data or a reply signal from an RFID tag of the refuse container. The sensor data can be obtained from sensors that are disposed on an exterior of the refuse vehicle. For example, the refuse vehicle can include cameras positioned about a body or cabin of the refuse vehicle that have a field of view pointing outwards from the refuse vehicle towards a location where refuse containers are expected to be located for pickup. Step 502 can be performed by the controller 102 or any other processing unit of the stream sorting system 400 by receiving image data from the cameras 402, RFID responses from the RFID detector 404, etc.

The process 500 includes inferring a type of refuse in the refuse container based on the sensor data (step 504), according to some embodiments. Step 504 can include performing an image analysis or image recognition technique based on features, colors, sizes, shapes, etc., of the refuse container in the image data. Step 504 can also include performing decoding techniques to decode the information contained in a QR cod or a barcode. Step 504 can also include analyzing a response from an RFID tag of the refuse container. Step 504 may be performed by the controller 102 by implementing at least one of the image analysis 406, the decoder 408, or the RFID manager 410.

The process 500 includes identifying if the refuse vehicle is a multi-compartment refuse vehicle (step 506), according to some embodiments. Step 506 may be performed based on known characteristics of the refuse vehicle. Step 506 can be performed by the controller 102. If the refuse vehicle is a multi-compartment refuse vehicle (step 506, “YES”), process 500 may proceed to step 508. If the refuse vehicle is not a multi-compartment refuse vehicle (step 506, “NO”), process 500 proceeds to step 510.

The process 500 includes operating at least one of a lift apparatus or a divider actuator to empty the refuse of the refuse container into one of the compartments of the refuse vehicle (step 508), according to some embodiments. Step 508 may include operating the lift apparatus 116 (e.g., a robotic arm, a side loading arm of a refuse vehicle, etc.) and the actuator 418 in order to empty the contents of the refuse container into one of the first compartment 68 or the second compartment 70 through the hopper 60. Step 508 may include operating the lift apparatus 116 to empty contents of the refuse container into a hopper opening corresponding to the desired compartment without requiring operation of the divider actuator if the lift apparatus 116 is operably capable of lifting the refuse container to different locations of the hopper. Step 508 can be performed by the controller 102 by generating and providing controls to the lift apparatus 116 and the actuator 418. Step 508 may be performed if the refuse vehicle is a multi-compartment refuse vehicle and has sufficient storage space in a target compartment for the contents of the refuse container.

The process 500 includes identifying if the type of refuse inferred at step 504 is supported by the refuse vehicle (step 510) if the refuse vehicle is not a multi-compartment refuse vehicle (step 506, “NO”), according to some embodiments. Step 510 may include using stored data regarding whether the refuse vehicle is intended to collect garbage or recycling or whether the refuse vehicle is currently collecting garbage, recycling, or a different type of refuse. Step 510 can be performed by the controller 102 based on known characteristics or current route of the refuse vehicle. Step 510 can include comparing the type of refuse that the refuse vehicle is intended to collect to the type of refuse that is inferred to be present within the refuse container. If the type of refuse that the refuse vehicle is intended to collect matches the type of refuse that is inferred to be present in the refuse container (step 510, “YES”), process 500 proceeds to step 512. If the type of refuse that the refuse vehicle is intended to collect does not match the type of refuse that is inferred to be present in the refuse container (e.g., the refuse vehicle is a garbage truck and the refuse container is a recycling bin) (step 510, “NO”), process 500 proceeds to step 514.

The process 500 includes operating the lift apparatus to empty the refuse into the refuse vehicle (step 512) in response to determining that the type of refuse inferred to be present in the refuse container matches or is supported by the refuse vehicle (step 510, “YES”), according to some embodiments. Step 512 can be performed by the controller 102 by operating the lift apparatus 116 to lift and empty contents of the refuse container into a hopper of the refuse vehicle 10.

The process 500 includes scheduling subsequent pickup of the refuse container (step 514) if the type of refuse inferred to be present in the refuse container does not match or is not supported by the refuse vehicle (step 510, “NO”), according to some embodiments. Step 510 can be performed by the controller 102 (e.g., by the pickup planner 412) by providing type of the container (e.g., type of the refuse inferred to be present in the refuse container) and a location (e.g., a GPS location) of the container to a remote computing system (e.g., a fleet management system, a route planning system, etc.) such as the remote computing system 134. The remote computing system can use the indication of the type of the container or refuse and the location to schedule pickup by an appropriate refuse vehicle. For example, if the refuse vehicle is a recycling truck and infers that the refuse container is a garbage can, the remote computing system may schedule and dispatch collection of the contents of the garbage can based on the type of the container and the location provided by the controller 102.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system for a refuse vehicle, comprising:
a camera oriented outwards from the refuse vehicle, the camera configured to obtain image data of a refuse container; and
processing circuitry configured to:
obtain the image data;
predict, based on the image data, a type of refuse in the refuse container; and
responsive to determining that the refuse vehicle is configured to collect the type of refuse in the refuse container, operate a lift apparatus of the refuse vehicle to empty the refuse in the refuse container into a hopper of the refuse vehicle.

2. The system of claim 1, wherein the processing circuitry is configured to use an image analysis technique using the image data to identify a feature of the refuse container and infer the type of refuse based on the feature of the refuse container

3. The system of claim 2, wherein the feature comprises at least one of a color of at least a portion of the refuse container, a size of the refuse container, a shape of the refuse container, a quick response code, a barcode, or a detected text on the refuse container.

4. The system of claim 1, further comprising a radio frequency identification (RFID) configured to wirelessly emit energy to an RFID tag of the refuse container, the processing circuitry configured to predict the type of refuse in the refuse container based on a received response from the RFID tag of the refuse container.

5. The system of claim 1, wherein the processing circuitry is further configured to, responsive to determining that the refuse vehicle is configured to collect the type of refuse in the refuse container, operating an actuator of a hopper partition such that the refuse is directed to a corresponding one of a plurality of refuse compartments of the refuse vehicle as the lift apparatus empties the refuse into the hopper.

6. The system of claim 1, wherein the processing circuitry is configured to, in response to determining that the refuse vehicle is not configured to collect the type of refuse in the refuse container, transmit a notification to a route planning system comprising a location of the refuse container, the route planning system configured to use the notification to dispatch a different refuse vehicle that is configured to collect the type of refuse in the refuse container to the location of the refuse container.

7. A refuse vehicle, comprising:
a lift apparatus; and
a system, comprising:
a camera oriented outwards from the refuse vehicle, the camera configured to obtain image data of a refuse container; and
processing circuitry configured to:
obtain the image data;
predict, based on the image data, a type of refuse in the refuse container; and
responsive to determining that the refuse vehicle is configured to collect the type of refuse in the refuse container, operate the lift apparatus of the refuse vehicle to empty the refuse in the refuse container into a hopper of the refuse vehicle.

8. The refuse vehicle of claim 7, wherein the processing circuitry is configured to use an image analysis technique using the image data to identify a feature of the refuse container and infer the type of refuse based on the feature of the refuse container

9. The refuse vehicle of claim 8, wherein the feature comprises at least one of a color of at least a portion of the refuse container, a size of the refuse container, a shape of the refuse container, a quick response code, a barcode, or a detected text on the refuse container.

10. The refuse vehicle of claim 7, further comprising a radio frequency identification (RFID) configured to wirelessly emit energy to an RFID tag of the refuse container, the processing circuitry configured to predict the type of refuse in the refuse container based on a received response from the RFID tag of the refuse container.

11. The refuse vehicle of claim 7, wherein the processing circuitry is further configured to, responsive to determining that the refuse vehicle is configured to collect the type of refuse in the refuse container, operating an actuator of a hopper partition such that the refuse is directed to a corresponding one of a plurality of refuse compartments of the refuse vehicle as the lift apparatus empties the refuse into the hopper.

12. The refuse vehicle of claim 7, wherein the processing circuitry is configured to, in response to determining that the refuse vehicle is not configured to collect the type of refuse in the refuse container, transmit a notification to a route planning system comprising a location of the refuse container, the route planning system configured to use the notification to dispatch a different refuse vehicle that is configured to collect the type of refuse in the refuse container to the location of the refuse container.

13. The refuse vehicle of claim 7, wherein the type of refuse comprises garbage or recycling.

14. The refuse vehicle of claim 7, wherein the refuse vehicle is equipped to contain a single type of refuse.

15. The refuse vehicle of claim 7, wherein the refuse vehicle is equipped to contain a plurality of types of refuse.

16. A method of operating a refuse vehicle, the method comprising:
obtaining image data of a refuse container from a camera of the refuse vehicle;
predicting a type of refuse within the refuse container based on the image data of the refuse container;
in response to determining that the refuse vehicle is equipped to collect the type of refuse in the refuse container, operating a lift apparatus of the refuse vehicle to empty the refuse into a hopper of the refuse vehicle.

17. The method of claim 16, wherein predicting the type of refuse comprises detecting, based on the image data, at least one of a color of at least a portion of the refuse container, a size of the refuse container, a shape of the refuse container, a quick response code, a barcode, or text on the refuse container.

18. The method of claim 16, further comprising, in response to determining that the refuse vehicle is configured to collect the type of refuse in the refuse container, operating an actuator of a hopper partition such that the refuse is directed to a corresponding one of a plurality of refuse compartments of the refuse vehicle as the lift apparatus empties the refuse into the hopper.

19. The method of claim 16, further comprising, in response to determining that the refuse vehicle is not equipped to collect the type of refuse in the refuse container, transmitting a notification to a route planning system comprising a location of the refuse container.

20. The method of claim 16, further comprising operating a user display to provide image data of the refuse container and an identification of the type of refuse.
